(19) United States
(12) Patent Application Publication
(10) Pub. No.: US 2025/0178107 A1
(43) Pub. Date: Jun. 5, 2025

(54) Self-Aligning Quick Change Jaw Set

(71) Applicant: Michael Richard Ramun, Mineral Ridge, OH (US)

(72) Inventor: Michael Richard Ramun, Mineral Ridge, OH (US)

(21) Appl. No.: 18/524,655

(22) Filed: Nov. 30, 2023

(51) Int. Cl. B23D 35/00; B23D 17/06

(52) U.S. Cl. CPC B23D 35/008; B23D 17/06

(57) ABSTRACT

A multiple tool attachment system is adapted to be attached to demolition equipment. The system includes a universal body attached to the demolition equipment. A series of tools are independently attachable to the universal body. Each tool generally includes a bridge housing with a pair of jaws that are pivotable relative to one another and adapted to be attached to the receiving member of a universal body. The multiple tool attachment system is provided with quick change features designed to optimize strength and ease of removing and installing the bridge housing.

### BACKGROUND OF THE INVENTION

### Field of the Invention

The present invention relates to a tool attachment system for demolition, recycling, and/or material processing equipment. More particularly, the present invention relates to a multiple tool attachment system for attaching tools having at least one movable jaw.

### Background Information

The present application refers to demolition, recycling, and/or material processing equipment. Such a description includes, but is not intended to be restrictive of, the equipment being referenced. Demolition equipment may include heavy duty metal cutting shears, grapples, and concrete processors, which may be mounted on excavators and other machinery, which power hydraulic cylinders for a variety of jobs in the demolition and recycling industries.

In the dismantling of an industrial structure, metal scrap in the form of various diameter pipes, structural I-beams, channels, angles, and sheet metal plates must be efficiently severed and handled by heavy duty metal shears. Metal shears can also be utilized for reducing automobiles, truck frames, and railroad cars. The shears must be able to move and cut the metal scrap into pieces without any significant damage to the shears. In the demolition of industrial structures, concrete crackers are also used to reduce concrete structures into to manageable components, which can then be easily handled and removed from the site. Wood shears and plate shears also represent specialized cutting devices, which are useful, in particular, for demolition or debris removal situations, depending upon the type of material to be cut. Further, a grapple is often utilized where handling of debris or workpieces is a primary function of the equipment. Historically, all of these pieces of equipment represent distinct tools having significant independent capital cost. Consequently, the demolition industry has tended to develop one type of tool associated with each body.

With regard to metal shears, one type of known shear is a shear having a fixed blade and a movable blade pivoted thereto. The movable blade is pivoted by hydraulic cylinder to provide a shearing action between the blades for severing the work pieces. Examples of this type of shear can be found in the previously granted U.S. Pat. No. 7,121,489 which is incorporated herein by reference.

U.S. Pat. No. 7,121,489 discloses a quick change system whereby single plate receiving members are secured to a bridge housing with a pair of opposing plates.

### SUMMARY OF THE INVENTION

A tool set is disclosed for coupling to the receiving member of a body having at least one hydraulically powered blade. The tool set has a pair of blades movable relative to one another and pivoted together about a main pivot pin, wherein the pivot pin has a longitudinal axis and has a bridge housing engaging the main pivot pin. The bridge housing with the main pivot pin intact therein is adapted to be detachably connected to the receiving member. At least one of the pair of blades is adapted to be detachably connected to the at least one hydraulic cylinder such that the tool set may be removed from or attached to the body without the need to disengage or engage the main pivot pin from the blades, thereby providing a quick release system for attaching the tool set to the body. The bridge housing has a projection with a first aperture adapted to be aligned and mated with a matching first aperture of the receiving member and adapted to be secured to the receiving member with a first keeper pin extending through the aligned first apertures. The bridge housing also has a support surface adapted to mate with a complimentary engaging surface of the receiving member and to align the respective apertures when securing the bridge housing to the receiving member.

Another embodiment of the subject invention is directed to a demolition tool having a body with a receiving member and at least one hydraulic cylinder mounted upon the body. The tool also has a tool set coupled to the receiving member of the body, wherein the tool set has a pair of blades movable relative to one another and pivoted together about a main pivot pin and has a bridge housing encasing the pivot pin. The bridge housing with the main pivot pin intact therein is detachably connected to the receiving member and at least one of the pair of movable blades is detachably connected to at least one hydraulic cylinder attached to the body. As a result, the tool set may be removed from or attached to the body without the need to disengage or engage the main pivot pin from the blades, thereby providing a quick release system for attaching the tool set to the body. The bridge housing has a projection with a first aperture aligned and mated with a matching first aperture of the receiving member and secured to the receiving member with a second keeper pin extending through the first apertures. The bridge housing also has a support surface which mates with a complimentary engaging surface of the receiving member and to align the respective apertures when securing the bridge housing to the receiving member.

### BRIEF DESCRIPTION OF THE DRAWINGS

FIG. 1 is a side view illustrating a tool set according to the present invention attached to a universal body for a construction tool system;

FIG. 2 is a perspective view of the tool set and universal body illustrated in FIG. 1, but with the jaws of the tool set in the closed position and the tool set separated from the universal body;

FIG. 3 is a perspective view of the bridge housing separated from the receiving member;

FIG. 4 is a partial perspective view from a different direction of the arrangement in FIG. 3;

FIG. 5 is a perspective view from a different direction of the arrangement in FIG. 3;

FIG. 6 is a plan view of the arrangement in FIG. 3;

FIG. 7 is a cross-sectional view along lines “7-7” of FIG. 6;

FIG. 8 is a side view of the bridge housing secured to the receiving member;

FIG. 9 is a plan view of the tool set with the bridge housing prior to engagement with the receiving member;

FIG. 10 is a plan view of the tool set with the bridge housing secured to the receiving member; and

FIG. 11 is an arrangement whereby one blade is fixed in the tool set.

### DESCRIPTION OF THE PREFERRED EMBODIMENTS

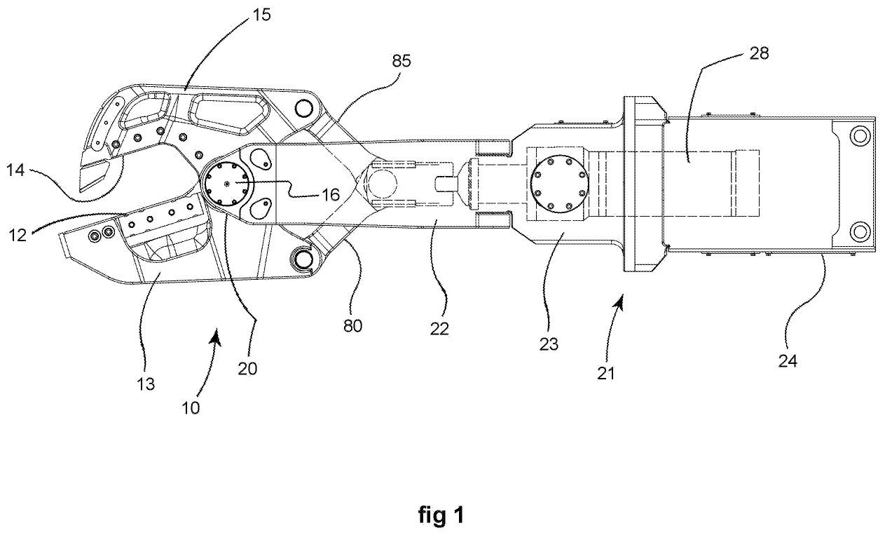

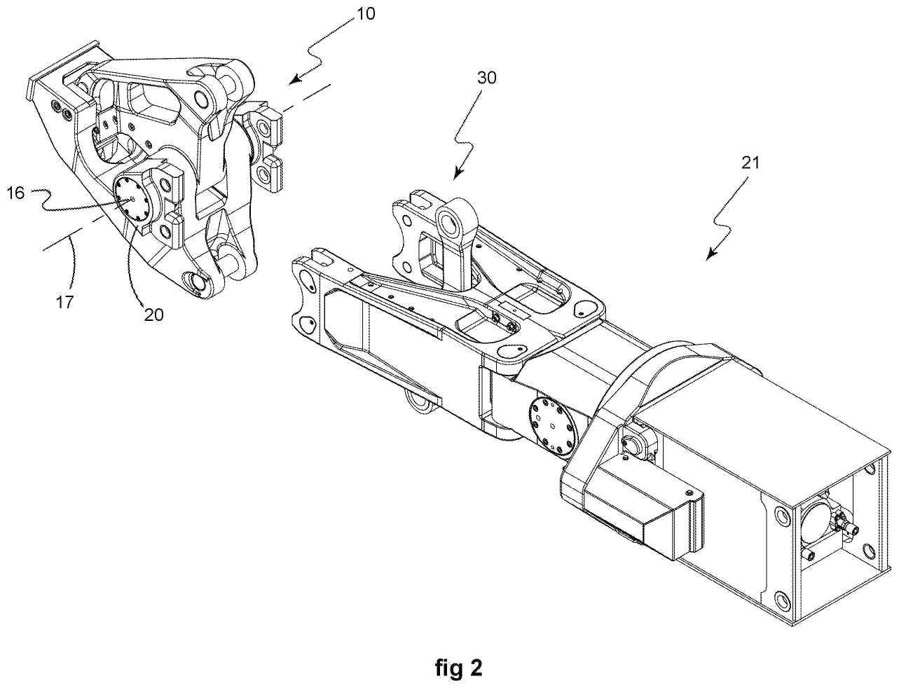

FIGS. 1 and 2 illustrate a multiple tool attachment adapted to be attached to demolition or construction equipment, such as an excavator (not shown), in accordance with the subject invention. The multiple tool attachment is adapted to connect one of a series of tool sets to the equipment. The tool attached in FIG. 1 is a metal shear 10. The shear 10 includes a first blade 12 connected to a lower jaw 13 and a second blade 14 connected to an upper jaw 15, wherein the jaws 13, 15 are pivotally connected at a hub or main pivot pin 16 with an axis 17 therethrough. The bridge housing 20 is connected to a universal body 21. The body 21 is referred to as universal because it remains common to a series of tool sets in the attachment system. The universal body 21 may be comprised of sides 22, a bearing housing 23, and a yoke 24.

As shown in FIG. 1, the blades 12, 14 may be driven by one or more hydraulic cylinders 28 connected to the universal body 21. Each blade 12, 14 is connected to a separate linkage 80, 85 through the jaws 13, 15 and these linkages 80, 85 are detachably connected to the at least one hydraulic cylinder 28.

As illustrated in FIGS. 1 and 2, the bridge housing 20 of the tool set 10 with the main pivot pin 16 intact therein is adapted to be detachably connected to the receiving member 30 of the bridge housing 20 and to the pair of blades 12, 14. At least one of the blades 12, 14 is adapted to be detachably connected through the jaws 13, 15 to at least one hydraulic cylinder 28 such that the tool set 10 may be removed from or attached to the universal body 21 without the need to disengage or engage the main pivot pin 16 from the blades 12, 14. This provides a quick release system for attaching the tool set 10 to the body 21.

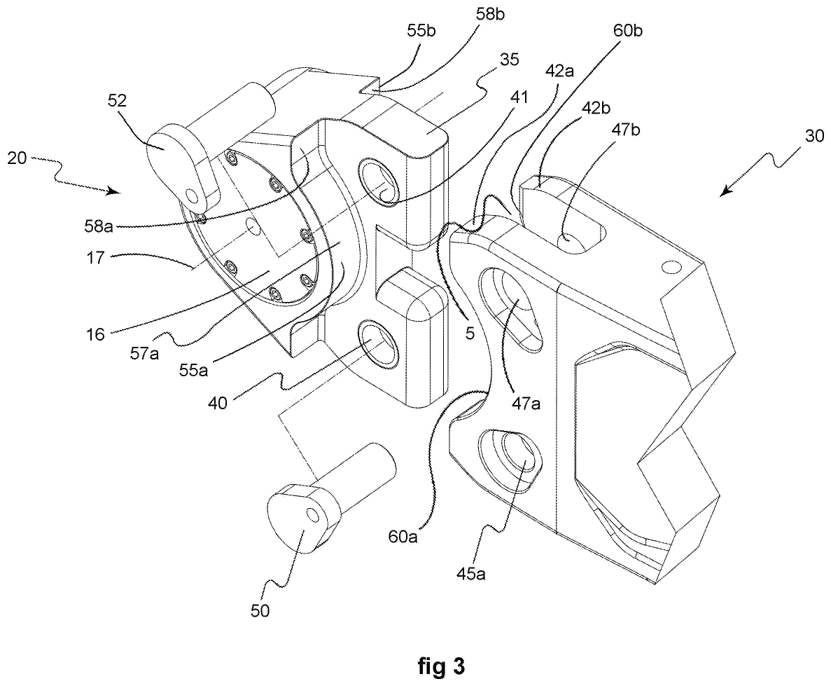

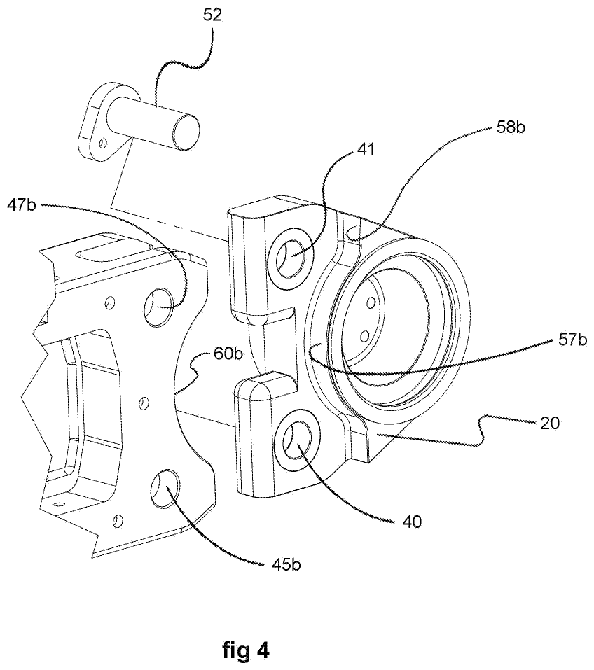

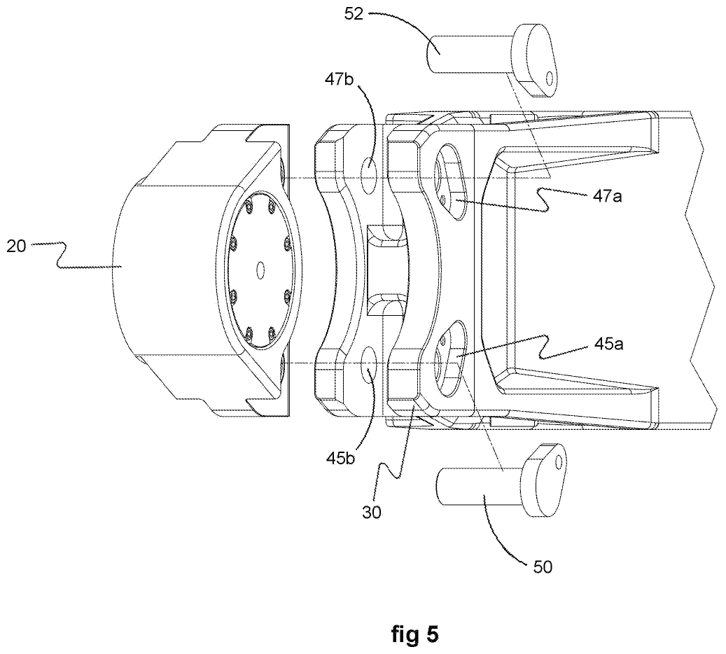

The bridge housing 20 is illustrated in greater detail in FIGS. 3-6 and has a single projection 35 with a first aperture 40 adapted to be aligned and mated with a matching first aperture 45a of the receiving member 30 through a first removable keeper pin 50 extending through the aligned first apertures 40, 45a to secure the bridge housing 20 to the receiving member 30.

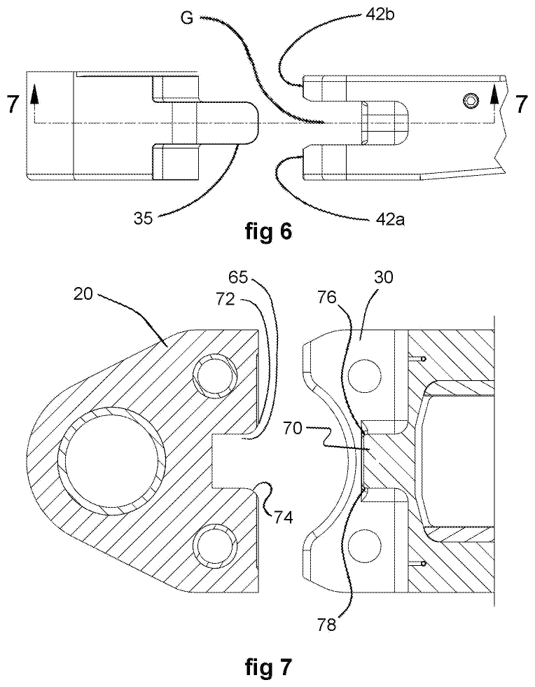

The bridge housing 20 has an inner support surface 55a on one side of the projection 35 and an outer support surface 55b on another side of the projection 35. The receiving member 30 has two extension plates 42a, 42b spaced apart and parallel to one another defining a receiving member gap G (FIG. 6) there between. Each extension plate 42a, 42b has a first aperture 45a, 45b extending there between and the first apertures 45a, 45a are coaxial with one another.

Each of the extension plates 42a, 42b of the receiving member 30 has complimentary engaging services 60a, 60b which conform to the inner support surface 55a and the outer support surface 55b of the bridge housing 20.

The apertures 45a, 45b of the receiving member 30 are aligned with the first aperture 40 of the bridge housing 20. The receiving member 30 and the bridge housing 20 are secured to one another with the first removable keeper pin 50 extending through the apertures 45a, 40, 45b.

As illustrated in FIGS. 3-5, the projection 35 of the bridge housing 20 may have a first aperture 40 and a second aperture 41 spaced apart from one another and from the main pivot pin 16. These apertures 40, 41 are adapted to be aligned and mated with matching apertures 45a, 47a and 45b, 47b of the extension plates 42a, 42b of the receiving member 30 using the removable keeper pins 50, 52.

Each of the inner support surfaces 55a and the outer support surface 55b of the bridge housing 20 may be arcuate. Each support surface 55a, 55b may have a convex surface 57a, 57b and a stop surface 58a, 58b. Each of the stop surfaces 58a, 58b prevents rotation of the bridge housing 20 when mated with the receiving member 30. Each of the stop surfaces 58a, 58b has a different contour than the convex surface 57a, 57b. As illustrated in FIG. 3, the stop surfaces 58a, 58b of the bridge housing 20 may be flat. Furthermore, there may be opposing stop surfaces at the other end of each of the support surfaces 55a, 55b. The inner support surface 55a of the bridge housing 20 mates with complimentary engaging surface 60a of the receiving member 30 and the outer support surface 55b of the bridge housing 20 mates with the complimentary engaging surface 60b of the receiving member 30.

FIG. 6 illustrates a top view of a portion of the arrangement illustrated in FIG. 3. FIG. 7 is a cross-sectional view of that portion shown along lines “7-7” in FIG. 6.

As illustrated in FIG. 7, the projection 35 of the bridge housing 20 includes a slot 65 adapted to mate with a matching protrusion 70 of the receiving member 30. It should be appreciated that while the bridge housing is illustrated with a slot 65 and the receiving member 30 is illustrated with a protrusion 70, this arrangement could be reversed such that the bridge housing has the protrusion and the receiving member has the slot. The slot 65 of the bridge housing 20 may have edges 72, 74 that are generally convex to make alignment with the protrusion 70 of the receiving member 30 easier. It is also possible for the protrusion 70 to have convex edges 76, 78 to conform to that of the slot 65 for easier assembly.

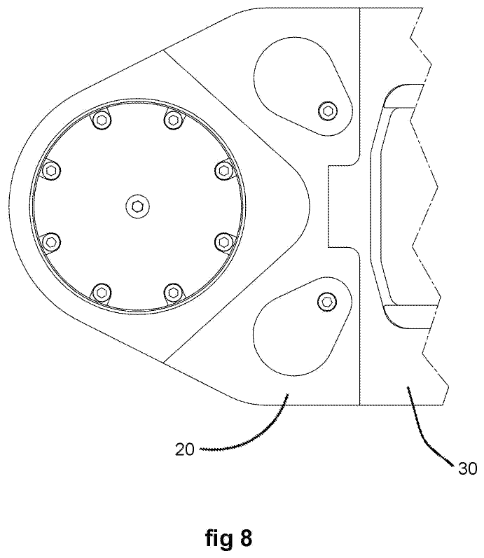

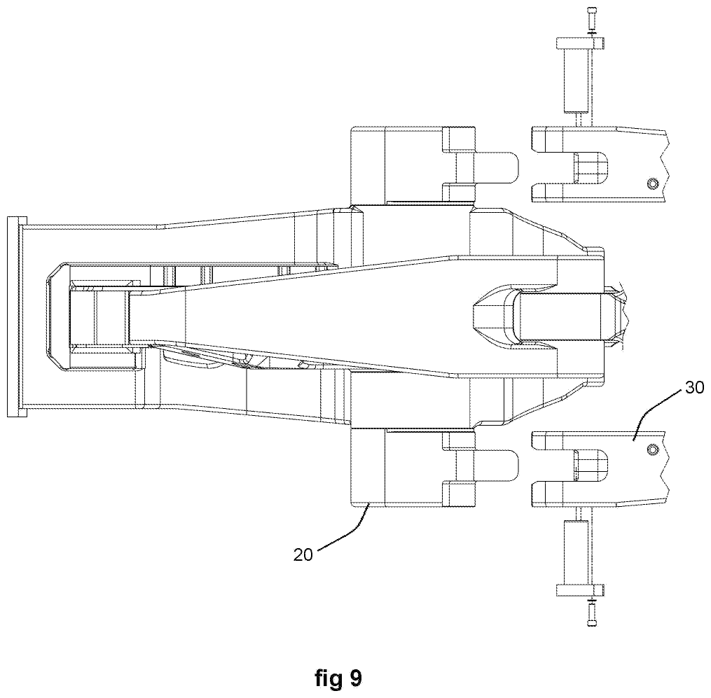

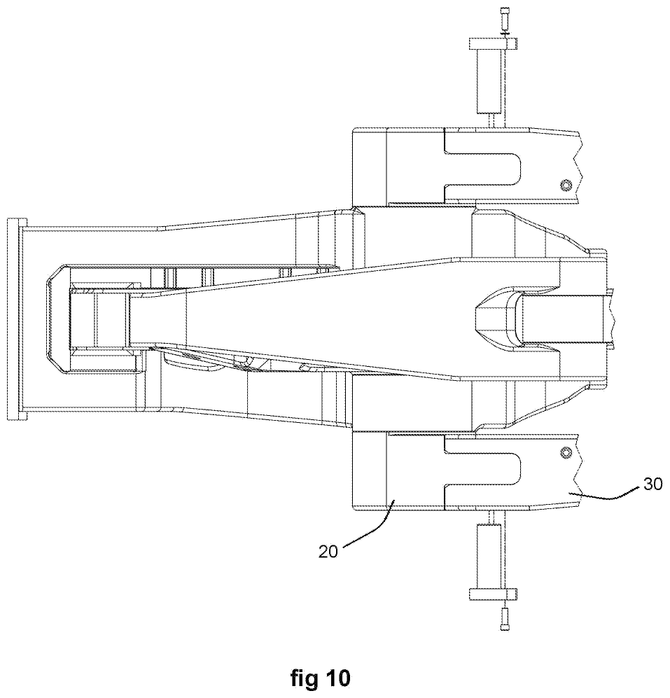

FIGS. 8-10 illustrate different views of these same elements to show features that may not be seen in other views.

What has so far been described is a tool set 10 that is coupled to the receiving member 30 of a universal body 21. The subject invention is also directed to a demolition or construction tool, as illustrated in FIGS. 1 and 2, made of both the bridge housing 20 and the receiving member 30. While many of the elements associated with the description of the bridge housing were adapted to mate with the receiving member 30, these elements are now described as mated with the receiving member 30.

The tool set 10 is coupled through the bridge housing 20 to the receiving member 30 of the universal body 21. The tool set 10 has a pair of blades 12, 14 pivoted together for relative rotation about a main pivot pin 16. The bridge housing 20 encases the main pivot pin 16. The bridge housing 20 with the main pivot pin 16 intact is detachably connected to the receiving member 30 and at least one of the blades 12, 14 is detachably connected through the respective jaw to at least one hydraulic cylinder 28 attached to the body 21 such that the tool set 10 may be removed from or attached to the body 21 without the need to disengage or engage the main pivot pin 16 from the blades 12, 14, thereby providing a quick release system for attaching the tool set 10 to the universal body 21.

The details of the bridge housing 20 and receiving member 30 are identical to those previously discussed.

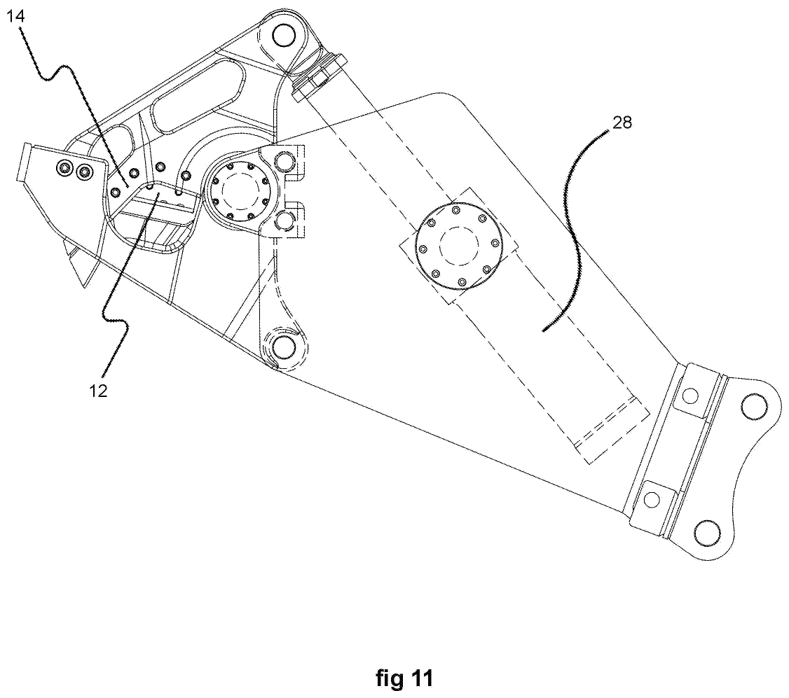

In an alternate embodiment to that of FIG. 1, as illustrated in FIG. 11, a single blade 12 is fixed. There is relative movement between the blades 12, 14. A single hydraulic cylinder 28 may be utilized to operate a single blade 14.

The present embodiments are merely intended to be illustrative of the present invention and not restrictive thereof. It would be apparent to those of ordinary skill in the art that various modifications may be made to the present invention without departing from the spirit and scope thereof.

The invention claimed is:

1. A tool set for coupling to the receiving member of a body having at least one hydraulically powered blade, the tool set comprising:
a) a pair of blades movable relative to one and pivoted together about a main pivot pin, wherein the pivot pin has a longitudinal axis;
b) a bridge housing engaging the main pivot pin, wherein the bridge housing with the main pivot pin intact therein is adapted to be detachably connected to the receiving member and at least one of the pair of blades is adapted to be detachably connected to the at least one hydraulic cylinder such that the tool set may be removed from or attached to the body without the need to disengage or engage the main pivot pin from the blades, thereby providing a quick release system for attaching the tool set to the body; and wherein the bridge housing has:
1. a projection with a first aperture adapted to be aligned and mated with a matching first aperture of the receiving member and adapted to be secured to the receiving member with a first keeper pin extending through the aligned first apertures; and
2. a support surface adapted to mate with a complimentary engaging surface of the receiving member and to align the respective apertures when securing the bridge housing to the receiving member.

2. The tool set according to claim 1, wherein the projection extends in a direction perpendicular to the longitudinal axis of the main pivot pin.

3. The tool set according to claim 1, wherein the bridge housing further comprises a second aperture adapted to be aligned and mated with a matching second aperture of the receiving member and adapted to be secured to the receiving member with a second keeper pin extending through the aligned second apertures.

4. The tool set according to claim 1, wherein the support surface of the bridge housing has a convex shaped portion to abut with a concave portion of the bridge housing and a stop surface which abuts with the bridge housing to prevent rotation of the bridge housing when mated with the receiving member.

5. The tool set according to claim 4, wherein the stop surface has a different contour than the convex surface.

6. The tool set according to claim 5, wherein the stop surface is flat.

7. The tool set according to claim 1, wherein the projection of the bridge housing includes a slot or protrusion adapted to mate with a matching protrusion or slot of the receiving member.

8. The tool set according to claim 7, wherein the protrusion has an end that has a shape that is generally concave to make alignment between the bridge housing and the with the receiving member easier.

9. A demolition or construction tool comprising:
a) a body having a receiving member, at least one hydraulic cylinder mounted upon the body, and two extension plates which are spaced apart and parallel to one another defining a receiving member gap there between, wherein each of the two extension plates has a first aperture extending there through and the first apertures of the extension plates are co-axial with one another;
b) a tool set coupled to the receiving member of the body, wherein the tool set has a pair of blades movable relative to one another and pivoted together about a main pivot pin and a bridge housing encasing the pivot pin;
c) wherein the bridge housing with the main pivot pin intact therein is adapted to be detachably connected to the receiving member and at least one of the pair of movable blades is adapted to be detachably connected to at least one hydraulic cylinder attached to the body such that the tool set may be removed from or attached to the body without the need to disengage or engage the main pivot pin from the blades, thereby providing a quick release system for attaching the tool set to the body; and wherein the bridge housing has:
1. a single projection along a plane with a first aperture aligned and mated with the first apertures of each extension plate of the receiving member and secured to the two extension plates of the receiving member with a first keeper pin extending through the first apertures of the projection and through the extension plates; and
2. a support surface which mates with a complimentary engaging surface of the receiving member and to align the respective apertures when securing the bridge housing to the receiving member.

10. The tool according to claim 9, wherein the bridge housing has two apertures spaced from one another and adapted to be mated with matching apertures of the receiving member through removable keeper pins to secure the bridge housing to the receiving member.

11. The tool according to claim 9, wherein the support surface and the engaging surfaces are arcuate.

12. The tool according to claim 9, wherein the support surface of the bridge housing has a convex surface and a stop surface and wherein the engaging surface has a concave surface and a stop surface such that when the bridge housing is engaged with the receiving member rotation is prevented.

13. The tool according to claim 12, wherein the stop surfaces have a different contour than the concave surface and the convex surface.

14. The tool according to claim 13, wherein the stop surfaces are flat.

15. The tool according to claim 9, wherein the projection has one of a slot or tab and the receiver has the other of a slot or tab such that when the bridge housing in engaged with the receiving member, the two parts engage with one another and prevent rotation provide support between the bridge housing and the receiving member.

16. The tool according to claim 9, wherein the projection has an end that is generally convex to be received within a projection of the receiving member that is generally concave.

17. The tool set according to claim 9, further including for each blade a separate linkage connected to that blade and adapted to be detachably connected to the at least one hydraulic cylinder.

18. The demolition tool according to claim 9, wherein the at least one hydraulic cylinder is a single hydraulic cylinder.
